(19) United States
(12) Patent Application Publication
(10) Pub. No.: US 2013/0279069 A1
(43) Pub. Date: Oct. 24, 2013

(54) Multifunction Charge Transfer Device

(71) Applicant: Paul Lenworth Mantock, Middlesex (GB)

(72) Inventor: Paul Lenworth Mantock, Middlesex (GB)

(21) Appl. No.: 13/824,544

(22) PCT Filed: Sep. 20, 2011
(86) PCT No.: PCT/GB11/01366

§ 371 Date: Mar. 18, 2013

(30) Foreign Application Priority Data
Sep. 20, 2010 (GB) 1015637.0

(51) Int. Cl. H01G 4/06

(52) U.S. Cl. CPC H01G 4/06
USPC 361/301.2

(57) ABSTRACT

A multifunction charge transfer device that limits and controls a current and voltage to a circuit or load, comprising at least one input and at least one output electrode as the charging electrode 10a and the discharging electrode 10b respectively, both in the form of closed continuous electrical loops. The charging electrode 10a and discharging electrode 10b in the form of closed continuous electrical loops are arranged side by side so that the edges of the electrical conducting material and the dielectric material 11a and 11b forming each closed continuous electrical loop are in alignment. The two closed continuous electrical loops are separated by a gap 12 to prevent any electrical contact between them and so that the charging electrode 10a and discharging electrode 10b can only be coupled by the electrostatic field concentrated at the side of the closed continuous electrical loop forming the charging electrode 10a. The charging and discharging electrodes 10a and 10b are each provided with connectors 13a and 13b respectively as a means for connection to an electric circuit in series.

### CROSS-REFERENCE TO RELATED APPLICATION

This application claims priority date of Patent Application No. 1015637.0 (GB) filed 2010 Sep. 20 by the present inventor.

### FEDERALLY SPONSORED RESEARCH

Not Applicable

### SEQUENCE LISTING OR PROGRAM

Not Applicable

### BACKGROUND OF INVENTION

### Field of Invention

The capacitor is used to store charge and it can also transmit an alternating current and when transmitting an alternating current a dielectric breakdown voltage has to be reached and then a charge is transmitted through the dielectric material with impedance having components of resistance, inductance and capacitance. This limits its use in transmitting alternating currents. The buffer capacitor as defined by the invention U.S. Pat. No. 7,782,595 has zero resistance and inductance, and apart from storing an electric charge it can transmits a limiting alternating current through it, by controlling the alternating current through it by means of its capacitive reactance and the value of voltage applied to it. However, it also has to reach a dielectric breakdown voltage before it can transmit an alternating current and like all capacitors, it blocks direct current, therefore direct current cannot be transmitted. Blocking a direct current is of course a very useful characteristic of capacitors and is applied to capacitive filtering and decoupling.

The electric transformer is well known. It is used to step-up or step-down alternating voltages and currents. This is possible because the transformer conserves electric power and by manipulating the number of turns of the primary and secondary windings voltages and currents can be stepped-up and stepped-down. These characteristics give it many uses in electronic and electrical circuits. However, the transformer is bulky and has losses in the form of heat, which requires cooling in some form and is a loss of energy.

The resistor and its usage are well known. It is used in AC and DC circuits to reduce voltage across it and current through it to values required in a circuit or load. However, to do this the resistor generates heat, which consumes and wastes energy and if the generated heat is not dissipated by a heat sink and in certain situations additional cooling by the use of a fan, can damage other electronic components, which can lead to circuit failure. Cooling by fan, adds to the complexity of the circuit and increases the energy consumption, thereby increasing further energy losses.

Both the resistor and the transformer cannot limit and control a current independently of the load; these two devices can be overloaded if they are not correctly power-matched to the load. In a situation where the transformer or the resistor is overloaded, will result in heat being generated, which can be severe enough to destroy each device or cause a circuit fire destroying the circuit and can lead to other serious consequences.

Both the buffer capacitor and the transformer when transmitting an alternating electric current conserve power. But if the capacitor, being coupled by the area of contact of the dielectric material between the charging and discharging electrodes, is used to step-up or step-down an alternating voltage by altering the dielectric area of contact between the charging and discharging electrodes, would only result in a capacitance change, due to the relationship of the dielectric material area of contact between the charging and discharging electrodes, hence it cannot be used with that type of coupling to step-up or step-down an alternating voltage. If the coupling of the charging and discharging electrodes of the capacitor can be coupled by the electrostatic field in similar way to the transformer, then by manipulating the areas of the charging and discharging electrode and dielectric materials, a component will result that can control the rate of discharge current and voltage to a load with many other useful functions.

When a conventional capacitor is charged the charge concentrates at the ends of the charging electrode and when it reaches a breakdown voltage the charge is discharged to the ends of the discharging electrode, behaving like a conductor with resistance and inductance, even when each end of the electrode is provided with a closed continuous electrical loop. The continuous electrical loops will prevent some charge concentrations at the ends of the electrode, but eventually all the charge will flow from the ends of such an electrode to the discharging electrode, and again it will behave like a conductor with resistance and inductance.

When a buffer capacitor is charged, the charge is stored in its dielectric material and concentrates as an electrostatic field (associated with corona discharge) around the side edges of the charging electrode because the closed continuous electrical loop has no end electrically. If the side edges of the charging and discharging electrodes are aligned side by side, the electrostatic field from the charging electrode will couple with the discharging electrode and induce a charge into the discharging electrode with an alternating or direct charging current. A charge will be transmitted from the charging electrode to the discharging electrode by the concentrated electrostatic field coupling, without reaching a dielectric breakdown voltage, hence direct or an alternating currents can be transmitted. This is strictly governed by the capacitance of each electrode and the output voltage, controlled by the surface area of the electrodes, enabling such a device to have multi-functions. It will function like transformer, a resistor and be able to limit the current to a load by its capacitive reactance and the applied voltage, minimal or zero power loss.

The present invention is a multifunction charge transfer device comprising a charging and a discharging electrode, both in the form of closed continuous electrical loops as defined by the invention U.S. Pat. No. 7,782,595. The charging and discharging electrodes in the form of closed continuous electrical loops are arranged side by side, so that the edges of the electrical conducting material and the dielectric material of each closed continuous electrical loops are in alignment. The two closed continuous electrical loops are separated by a gap to prevent any electrical contact between them, so that the charging and discharging electrodes can only be coupled by the electrostatic field, concentrated at the side edges of the charging electrode, because the closed continuous electrical loop forming each charging and discharging electrodes have no ends electrically. The charging and discharging electrodes are each provided with a connector as a means for connection to an electric power source and an electric circuit. The assembly of the side by side aligned charging and discharging electrodes are enclosed by an electric conducting material which is insulated from the charging and discharging electrodes by an electric insulating material, ensuring that the electrostatic field in contained.

When the charging electrode is charged by an alternating current or a direct current the charging electrode is charged and an electrostatic field is generated. It is transferred across the gap and a charge is induced into the discharging electrode and instantaneously discharged to the circuit as a current. The voltage and current of the charging and discharging electrodes will be the same, provided the geometry and the dielectric constant of the dielectric material are the same and the surface areas of the charging and discharging electrodes are equal.

When an alternating current being transmitted through the multifunction charge transfer device by the charging and discharging electrodes, the transmitted current I amps is related to the supply voltage Vs volts, the capacitance C farads of each electrode and by the frequency f hertz of the supply voltage and is rigidly governed by the following general equation;

I=2πfCVs amps.

And when a direct current is being transmitted through the multifunction charge transfer device e by the charging and discharging electrodes, the transmitted current I amps is related by the supply voltage Vs volts its capacitance C farads and is rigidly governed by the following equation;

I=CVs/t amps.

The capacitance for DC applications can be calculated by considering the case where the current I is required to generate heat for the AC and DC cases are equal and the voltage Vs is known, then,

I_{DC}=I_{AC}=CVs/t=2πfCVs, therefore t=1/2πf, where I_{AC} is an rms value.

The capacitance C of the charging and discharging electrodes is given by the general equation,

C=kokA/d,

Where, ko=permittivity of free space, k=the dielectric constant, A=area d electrode and d=dielectric thickness.

In each case of AC or DC supply, the charging and discharging electrodes, the charge Q coulombs being transmitted will be equal, therefore if the charging and discharging electrodes have capacitance Ca and Cb respectively, then in case of the charging and discharging electrodes,

Qa=Qb and therefore CaVs=CbVs

By the manipulation of the surface area dimensions, the dielectric constant of the dielectric materials and or the geometry and the dielectric constant of the dielectric materials of the charging and discharging electrodes. Such that the Qa charging the charging electrode if not equal to the charge Qb discharging from the discharging electrode. Therefore if the charging and discharging electrodes have capacitance Ca and Cb respectively, then in case of the charging and discharging electrodes,

Qa≠Qb and therefore CaVs≠CbVs coulombs

In this case it is the discharging electrode that limits and controls the discharging current and voltage.

With these characteristics the multifunction charge transfer device will have different embodiments and can be used as component to limit and control a current to a load at a constant voltage, to step-up or step-down a voltage and keeping the current constant. It can be used like a resistor to reduce a voltage and current, but with the discharging current and voltage being limited and controlled capacitive and the dimensional area of the discharging electrode respectively. When the charging electrode has a smaller surface area than the discharging electrode, it can be used to achieve unidirectional current flow, when connected to an alternating current power supply.

In all applications, the multifunction charge transfer device is strictly governed by the capacitive reactance and voltage of the discharging electrode, when transmitting an alternating current. And is strictly governed by the capacitance and applied voltage of the discharging electrode when transmitting a direct current. In each case of transmitting alternating or direct current the multifunction charge transfer device power will be conserved. Power in will always be equal to power out and it cannot be overloaded, irrespective of the load, it limits and controls the current to the load provided the load is less than the load capacity of the multifunction charge transfer device.

The invention is explained by use of the following drawings:

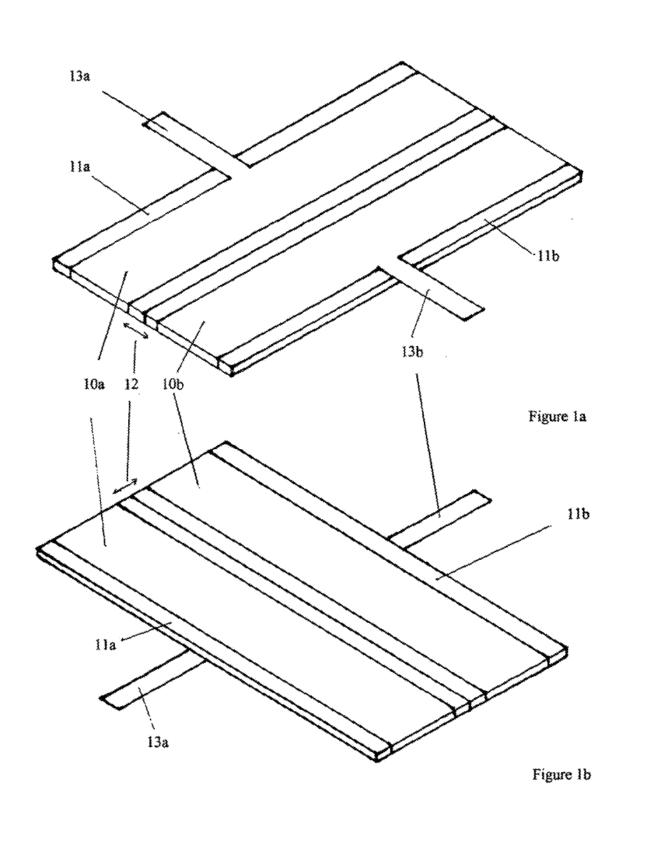

FIG. 1a shows in perspective a top view of the arrangement of the charging and discharging electrodes in the form of closed continuous electrical loops.

FIG. 1b shows in perspective a bottom view of the arrangement of the charging and discharging electrodes in the form of closed continuous electrical loops.

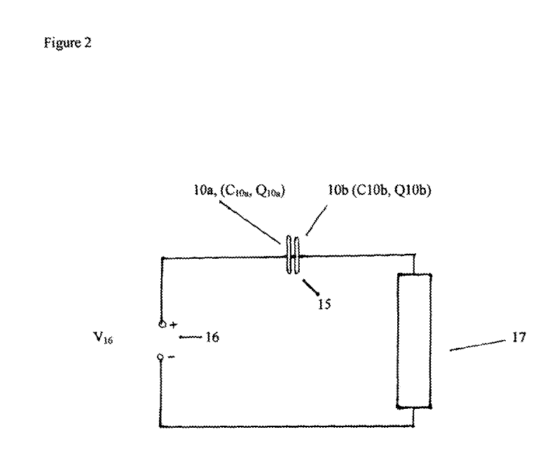

FIG. 2 shows the multifunction charge transfer device connected in an electric circuit and showing the charging and discharging electrodes electrically connected, depicting it transmitting direct and alternating currents.

From FIG. 1a and FIG. 1b the present invention is a multifunction charge transfer device comprising at least one charging electrode 10a and at one discharging electrode 10b both in the form of closed continuous electrical loops as defined in U.S. Pat. No. 7,782,595. The charging electrode 10a and discharging electrode 10b in the form of closed continuous electrical loops are arranged side by side so that the edges of the electrical conducting material and the dielectric material 11a and 11b forming each closed continuous electrical loop are in alignment The two closed continuous electrical loops are separated by a gap 12 to prevent any electrical contact between the charging electrode 10a and the discharging electrode 11b so that the charging electrode 10a and discharging electrode 10b can only be coupled by the electrostatic field, concentrated at the side edges of the closed continuous electrical loop forming the charging electrode 10a. The charging and discharging electrodes 10a and 10b respectively, are each provided with connectors 13a and 13b respectively, as a means for connection to an electric circuit, (FIG. 2).

The assembly of the side by side aligned charging electrode 10a and discharging electrode 10b are enclosed by an electric conducting material (not shown) which is insulated from the charging and discharging electrodes by an electric insulating material (not shown), ensuring that the electrostatic field in contained.

When the multifunction charge transfer device 15 is connected, as in a circuit FIG. 2, with an alternating or direct power supply 16 of voltage V₁₆ volts and a load 17 with an alternating or direct current, the charging electrode 10a is charged by an amount Q₁₀ₐ=C₁₀V₁₆ coulombs and because it is coupled to the discharging electrode 10b by the electrostatic field generated and concentrated at the edges of the electric conducting material, forming the charging electrode 10a. The electrostatic field concentrated at the charging electrode 10a induces a charge Q_{10b}=C_{10b}V₁₆ coulombs into the discharging electrode 10b, which is instantaneously discharged to the load 17, (FIG. 2) as an alternating or direct current.

When the charging and discharging electrodes 10a and 10b respectively have areas of equal dimensions and the dielectric material 11a and 11b within the charging electrode 10a and discharging electrode 10b the are the same with the same dimensions, then,

Q₁₀ₐ=Q_{10b}, then C₁₀ₐV₁₆=C_{10b}V₁₆ coulombs.

An equal charge will be transferred from the charging electrode 10a to the discharging electrode 10b and will be discharged as an alternating or direct current at a constant voltage V₁₆ can be transmitted that is rigidly controlled by the capacitance of the discharging electrode 10b. The multifunction charge transfer device 15 as in FIG. 2 can be used a component to limit and control a current to any load, irrespective of the current requirement of the load 17. And in the case of an alternating current it can be used for in series phase correction and harmonic current decoupling, since it has zero inductance.

When the capacitance C_{10b} of the discharging electrode 10b is less than or more than the capacitance C₁₀ₐ of the charging electrode 10a by reduced dielectric constant k of the dielectric material 11a and or increasing the dielectric material 11a thickness d of the discharging electrode 10b, but keeping the surface area dimensions of the charging electrode 10a and discharging electrode 10b such that the charge in conserved, then,

Q₁₀ₐ=Q_{10b}then C₁₀ₐV₁₀ₐ=C_{10b}V_{10b} and C₁₀ₐ/C_{10b}=V_{10b}/V₁₀ₐ.

Then, the multifunction charge transfer device 15, as in FIG. 2, can be used like a transformer to step-down or step down a current and voltage, while discharging electrode 10b will discharge a current equal to the current charging the charging electrode 10a, and the discharging electrode 10b limits and control the current and voltage to the load 17.

Since the general equation of capacitance C=kokA/d where ko=permittivity of free space, k=the dielectric constant, A=area d electrode and d=dielectric thickness.

When the capacitance C_{10b} of the discharging electrode 10b is less than the capacitance C₁₀ₐ by reduced dielectric constant k of the dielectric material 11a and or increasing the dielectric material 11a thickness d of the discharging electrode 10b, but keeping the surface area dimensions of the charging electrode 10a and discharging electrode 10b equal, the multi-function charge transfer device can be used to step-down a current, with a constant voltage where V₁₀ₐ=V_{10b}, and the discharging electrode 10b limits and control the current to the load 17.

When the surface area dimensions of the charging electrode 10a is greater than the discharging electrode 10b and the capacitance C₁₀ₐ of the charging electrode 10a and the capacitance C_{10b}, of the discharging electrode 10b are such that the voltage across the discharging electrode 11b is stepped-down. The charge Q₁₀ₐ charging the charging electrode 11a will not be equal to charge Q_{10b}, being discharged from the discharging electrode 11b, then,

Q₁₀ₐ≠Q_{10b} and therefore C₁₀ₐV₁₀ₐ≠C_{10b}V_{10b} coulombs

hence the current being discharged from the discharging electrode 10a will be stepped-down the multifunction charge transfer device 15 as in FIG. 15 can function like a resistor to reduce a voltage and current to the load 17, and the discharging electrode 11b limits and control the discharging current to the load 17.

When the charging electrode 11a has a smaller surface area than the discharging electrode 11b, it can be used to achieve unidirectional current flow, because when the charging electrode 11a is connected to an alternating current power supply and the charge is transferred to the charging electrode 10b. The discharging electrode 10b will only transmit half cycle of the same polarity for each cycle of the alternating current.

1. A multi-function charge transfer device comprising;
at least one charging electrode and at least one discharging electrode and the said charging electrode and the said discharging electrode, each being in the form of a closed continuous electrical loop, as defined in the invention U.S. Pat. No. 7,782,595, where therein, each electrode in the form of the said closed continuous electrical loop has no ends electrically, thereby concentrating the electrostatic field at the side edges of the said charging electrode
and the said charging and the said discharging electrode being arranged side by side in alignment and being separated by an appropriate gap and the said appropriate gap being the means preventing any electric contact between the said charging electrode and the said discharging electrode
and the said charging electrode being provided with a connector and is the means by which the said charging electrode is connected to an electric circuit and charged from an alternating current power source
and the said discharging electrode being provided with a connector
and the said connector is the means which the said transferred charge is connected to an electric circuit and when the said charging electrode is charged from the said alternating current power supply generating an electrostatic field at the edges of the said charging electrode
and the said electrostatic field is the means by which the said charging electrode and the said discharging electrodes are coupled across the appropriate gap
and the said electrostatic field is the means by which the electrostatic charge is transferred instantaneously from the said charging electrode to the said discharging electrode thereby being discharged instantaneously from the said discharging electrode to the said circuit as a current that is related to the capacitance of the said discharging electrode and at a voltage that is related to the surface area of the said discharging electrode
and the assembly of the side by side aligned said charging electrode and the said discharging being enclosed by an electric conducting material
and the said electric conducting material being electrically insulated from the said charging electrode and the said discharging electrode and it is the means by which the generated electrostatic filed is contained.

2. A multi-function charge transfer device comprising;
at least one charging electrode and at least one discharging electrode and the said charging electrode and the said discharging electrode, each being in the form of a closed continuous electrical loop, as defined in the invention U.S. Pat. No. 7,782,595 where therein, each electrode in the form of the said closed continuous electrical loop has no ends electrically, thereby concentrating the electrostatic field at the side edges of the said charging electrode
and the said charging and the said discharging electrode being arranged side by side in alignment and being separated by an appropriate gap and the said appropriate gap being the means preventing any electric contact between the said charging electrode and the said discharging electrode
and the said charging electrode being provided with a connector and is the means by which the said charging electrode is connected to an electric circuit and charged from an direct current power source
and the said discharging electrode being provided with a connector and the said connector is the means which the said transferred charge is connected to an electric circuit
and when the said charging electrode is charged from the said direct current power supply generating an electrostatic field at the edges of the said charging electrode and the said electrostatic field is the means by which the said charging electrode and the said discharging electrodes are coupled across the appropriate nap and the said electrostatic field is the means by which the electrostatic charge is transferred instantaneously from the said charging electrode to the said discharging electrode thereby being discharged instantaneously from the said discharging electrode to the said circuit as a current that is related to the capacitance of the said discharging electrode and at a voltage that is related to the surface area of the said discharging electrode
and the assembly of the side by side aligned said charging electrode and the said discharging being enclosed by an electric conducting material
and the said electric conducting material being electrically insulated from the said charging electrode and the said discharging electrode and it is the means by which the generated electrostatic filed is contained.

3. A multifunction charge transfer device comprising;
at least one charging electrode and at least one discharging electrode, both in the form of a closed continuous electrical loop as defined in the invention U.S. Pat. No. 7,782,595 and the said charging electrode being of a smaller surface area than the said discharging electrode
and when the said charging electrode is connected to an alternating power supply and the said discharging electrode is connected to a circuit the said charging electrode is charged the said charge is transferred to the said discharging electrode
and the said discharging electrode will only discharge a half cycle of the same polarity for each cycle of the said alternating current as a unidirectional current flow to the circuit
and the assembly of the side by side aligned said charging electrode and the said discharging being enclosed by an electric conducting material
and the said electric conducting material being electrically insulated from the said charging electrode and the said discharging electrode and it is the means by which the generated electrostatic filed is contained.

4. A multifunction charge transfer device as in claim 1, claim 2 and claim 3 wherein;
there is provided at least one said charging electrode and at least one said discharging electrode in the form of closed continuous electrical loops and the at least one charging electrode
and the at least one discharging electrode in side by side alignment and being electrically coupled by an electrostatic field and having surface area and capacitance relative to each other.

5. A multifunction charge transfer device as in claim 1, claim 2 and claim 3 wherein;
there is provided at least one charging electrode in the form of a closed continuous electrical loop.

6. A multifunction charge transfer device as claim 1, claim 2 and claim 3 wherein; there is provided at least one discharging electrode in the form of a closed continuous electrical loop.

7. A multifunction charge transfer device as in claim 3 wherein;
there is provided at least one charging and at least one discharging electrode, both in the form of closed continuous electrical loops
and the said charging having a surface area greater than the said discharging electrode.
